(19) United States
(12) Patent Application Publication
(10) Pub. No.: US 2003/0229501 A1
(43) Pub. Date: Dec. 11, 2003

(54) Systems and methods for efficient policy distribution

(76) Inventors: Bruce Wayne Copeland, Redmond, WA (US); Daniel Nicholas Joseph Drew, Bothell, WA (US); John Leo Ellis, Sammamish, WA (US); Kenneth Mark Osborne, Sammamish, WA (US); Zhengkai Kenneth Pan, Redmond, WA (US); Gopal Parupudi, Issaquah, WA (US); Russell Todd Wilson, Redmond, WA (US)

Correspondence Address: LEE & HAYES PLLC, 421 W RIVERSIDE AVENUE SUITE 500, SPOKANE, WA, 99201

(21) Appl. No.: 10/162,851

(22) Filed: Jun. 3, 2002

(51) Int. Cl. G06F 17/60

(52) U.S. Cl. 705/1

(57) ABSTRACT

The following described implementations provide for efficient distribution of policy. Specifically, a policy is generated that includes an action to be applied to a resource. A policy assignment is created in association with but separate from the policy. The policy assignment includes a reference to the policy, as well as criteria for a client to determine appropriateness of subsequent access to the policy to apply the action to the resource.

### TECHNICAL FIELD

The following description relates to enterprise management. More particularly, the disclosed subject matter pertains to the installation, configuration, and maintenance of software applications across enterprise networks.

### BACKGROUND

The Internet and the World Wide Web (www) have had a dramatic effect on corporate networks, with companies using them for electronic commerce and Internet access as well as client/server applications and traditional network services such as e-mail. Efficient systems and network management practices can cut and control costs by enabling efficient asset management practices, reducing the need for labor-intensive tasks such as the installation, maintenance, and reconfiguration of software, minimizing the cost of wide area data communication links, minimizing the cost of systems related downtime, providing the proper level of services, and much more.

Responsive to environmental changes in the enterprise (e.g., users logging on/off, a change of network connectivity, software installation, configuration, updates, repairs, and so on), proper systems, software, and network management practices typically include the distribution and implementation of policy to address the environmental changes. Unfortunately, conventional systems and techniques for enterprise-wide distribution and implementation of policy are substantially limited for a number of reasons.

One limitation, for example, is that distribution of policy typically requires client devices throughout the enterprise to periodically verify that client components are correctly installed and working properly. This verification cycle can have negative effects in environments where network bandwidth and/or processing resources are limited. This is because each client device typically downloads all policy information from policy server's client access point (CAP Management Point (MP). Although, the amount of data that a client device downloads depends on the actual amount of policy information on the policy server, it is not unusual for the amount of data to reach into the tens, twenties, and so on, megabytes (MB) of policy information data. Downloading so much data to client devices can have detrimental effects on policy server processing resources as well as a negative impact on network throughput in networks with limited bandwidth. Even with LAN type bandwidth there can be a negative impact when there are thousands of clients—a common scenario in a typical large enterprise.

The following described arrangements and procedures address these and other limitations of traditional systems and procedures to distribute and implement policy.

### SUMMARY

The disclosed subject matter provides for the efficient distribution of policy. Specifically, a policy is generated that includes an action to be applied to a resource. A policy assignment is created in association with but separate from the policy. The policy assignment includes a reference to the policy, as well as criteria for a client to determine appropriateness of subsequent access to the policy to apply the action to the resource.

### BRIEF DESCRIPTION OF THE DRAWINGS

The same numbers are used throughout the drawings to reference like features and components.

FIG. 1 shows an exemplary system to efficiently distribute policy from a policy server across a communication path such as a network (e.g., an organizational intranet and/or the Internet) to any number of client devices.

FIG. 2 shows an exemplary block diagram of a policy assignment object.

FIG. 3 is a block diagram that shows aspects of an exemplary policy object.

FIG. 4 shows an exemplary procedure to efficiently distribute policy.

### DETAILED DESCRIPTION

The following description sets forth exemplary subject matter to efficiently distribute policy. The subject matter is described with specificity to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies.

Overview

Conventional techniques to distribute and implement policy (e.g., machine, application, and/or user policy) in an enterprise typically require each client in the enterprise to download a potentially prohibitive amount of policy information across network resources over a period of time. To make matters worse, this is the case regardless of whether policy being downloaded even applies to the client device (i.e., a policy may be targeted to only a specified subset of the devices in the enterprise). This downloaded policy information can include any number of software settings, possibly tens, hundreds, or thousands of such settings that are needed by the client device to properly evaluate whether or not a downloaded policy applies to a particular device, application, and/or user of the device. In the case that the policy does apply to the machine, application, or user, the downloaded policy information also includes the computer programs or scripts, which are used to properly install, configure, and execute the contents of the package on the particular device. Accordingly, conventional policy distribution techniques generally require utilization of a considerable and potentially prohibitive amount of network bandwidth and/or processing resources to distribute policy information to client devices, which may or may not be able to utilize the downloaded policy information.

In contrast to such conventional techniques to distribute and implement policy, the described subject matter efficiently distributes policy to client devices in an enterprise by keeping the amount of policy information communicated between a policy server and client device to a substantial minimum. More specifically, a policy is generated that includes an action to be applied to a resource. A policy assignment is created in association but separate from the policy. The policy assignment includes a reference to the policy, as well as criteria for a client to determine appropriateness of subsequent access to the policy to apply the action to the resource.

This allows a client device to substantially determine which policy information on the policy server applies to the client prior to requesting one or more particular policies from the policy server. Thus, the described subject matter additionally provides for selective configuration by a system administrator of the policy server's policy downloading behavior based on the particular policy needs of a client device, rather than requiring the policy server to download all policies to each requesting client device—regardless of whether or not a downloaded policy even applied to the client device.

Accordingly, since efficient movement of policy information is crucial to the proper management of essentially limited network bandwidth and/or processing resources in an enterprise, the described subject matter can substantially optimize the particular processing and network resources utilized in the enterprise to distribute and implement enterprise-wide policy. These and other exemplary aspects of subject matter to efficiently distribute and implement policy in an enterprise are now described.

An Exemplary System

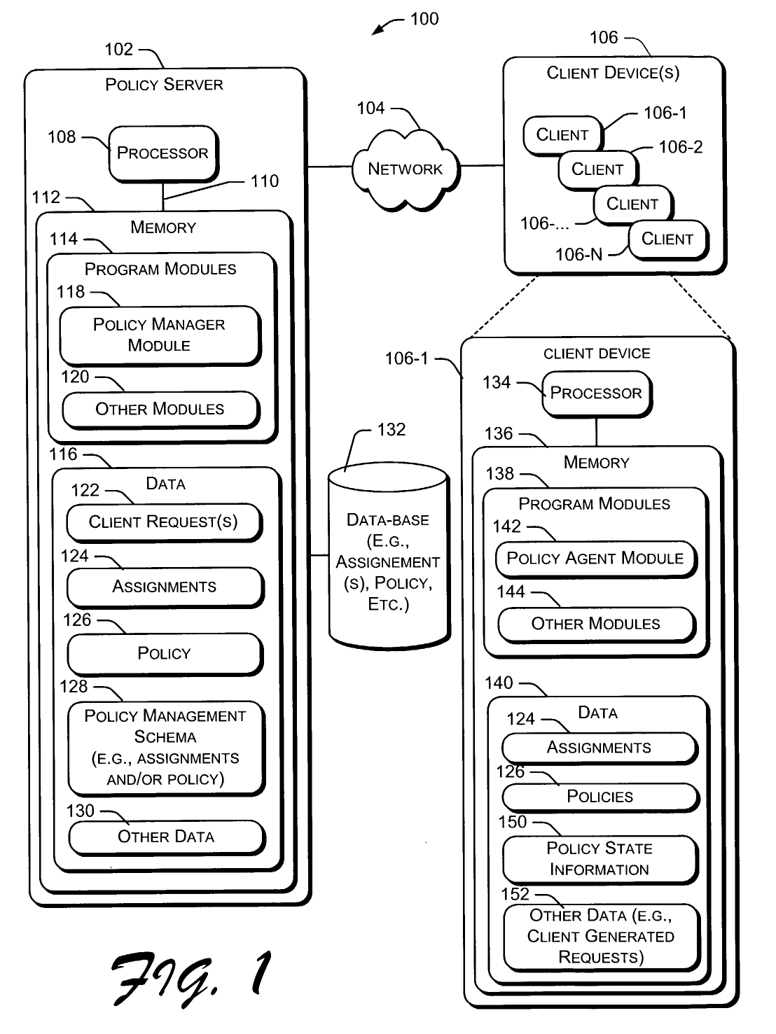

FIG. 1 shows an exemplary system 100 to efficiently distribute policy from a policy server 102 across a communication path 104 such as a network (e.g., an organizational intranet and/or the Internet) to any number of client devices 106. More specifically, the client device 106 communicates client generated requests (e.g., see other data 152 and the client generated requests) to the policy server 102m wherein the requests are identified as requests 122, to receive one or more policy assignment objects 124. As described in greater detail below in reference to TABLE 1, the client 106 can selectively retrieve machine, user, and/or application-specific assignment objects 124 by formatting a particular policy assignment object request 122 such that only specific types of assignments 124 are returned by the policy manager module 118 to the requesting client device 106 for subsequent evaluation.

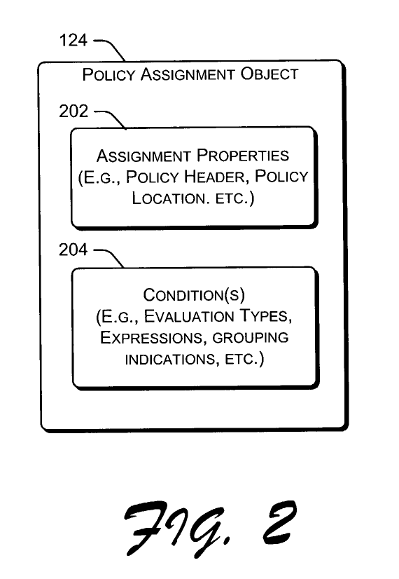

Responsive to receiving a policy assignment request 122, the policy server communicates one or more policy assignment objects 124 to the client device 106. Upon receiving a particular policy assignment object 124 from the policy server 102, the policy agent module 142 evaluates the received policy assignment object 124, and more specifically evaluates the conditions 204 of FIG. 2 to determine whether corresponding policy 126 should also be downloaded from the policy server. If the conditions 204 are not met, the policy agent module 142 does not need to download the corresponding policy object 126 from the policy server 102, thereby not unnecessarily utilizing limited policy server 102 processing resources or limited network bandwidth resources to download unneeded policy information.

For instance, consider that following a boot-up of a client 106, which in this example is also a server, the client 106 retrieves only those policy assignments 124 from the policy server 102 that apply to machine policy. Subsequent to evaluating any conditions 204 corresponding to the received policy assignments 124, the client 106 downloads only those policy objects 126 that specifically apply to its particular boot-up environment.

Further consider that responsive to a particular application such as a remote access service (RAS) being configured on the server 106, and responsive to a user connecting to the server 106, the server 106 can download policy assignments 124 from the policy server 102 that are specifically directed to application resources and/or user resources. After evaluating the downloaded assignments 124, the server 106 can particularly specify those policy objects 126 that are to be downloaded and subsequently applied to aspects of the RAS application's execution environment and/or aspects of the connecting user's execution environment. It can be appreciated that many other scenarios for specifically evaluating, specifying, and applying resource type specific policies 126 by a client device 106 can be described.

Accordingly, and in contrast to traditional systems and techniques to distribute and implement policy, which require a client device to download all assignments and all policy before determining which, if any, of the downloaded policies correspond to the client device, the described subject matter separates aspects of policy assignments 124 (i.e., policy 126 applicability criteria) from actual policy 126. This enables a client device 106 to specifically download only those assignments which applied to a particular phase of the client device's operation. We now further describe these and other aspects of the exemplary system 100.

### An Exemplary Policy Server

The policy server 102 includes a processor 108 coupled across a bus 110 to a system memory 112. Bus 110 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

The system memory 112 includes a variety of computer-readable media. Such media may be any available media that is accessible by the processor 108, and it includes both volatile and non-volatile media, removable and non-removable media. For example, the system memory 112 includes computer readable media in the form of volatile memory, such as random access memory (RAM), and/or non-volatile memory, such as read only memory (ROM). A basic input/output system (BIOS), containing the basic routines that help to transfer information between elements within computer 102, such as during start-up, is stored in ROM. RAM typically contains at least portions of program modules 114 and/or data 116 that are immediately accessible to and/or presently be operated on by the processor 108.

The processor 108 is configured to fetch and execute computer program instructions from applications or program modules 114 portion of memory 112. The processor 108 is also configured to fetch data from the data 116 portion of memory 112 while executing the program modules 114.

Program modules 114 may be described in the general context of computer-executable instructions being executed by a computer. Generally, program modules 114 include routines, programs, objects, components, data structures, etc., that perform particular tasks or implement particular abstract data types. Exemplary systems and procedures to efficiently distribute policy to any number of client devices 106 in an enterprise network 100 may be performed by program modules 114 that are executing on remote processing devices that are linked through a communications network. Accordingly, program modules 114 may be located in both local and remote computer storage media including memory storage devices (e.g., an SQL database 130, which is coupled to the policy server 102).

The program modules 114 of the policy server include, for example, the policy manager module 118, and other modules 120 such as an operating system. Data 116 includes policy assignment objects 124, policy objects 126, a policy assignment schema 128, and other data 130 such as policy bundles. We now describe further aspects of the program modules 114 and data 116.

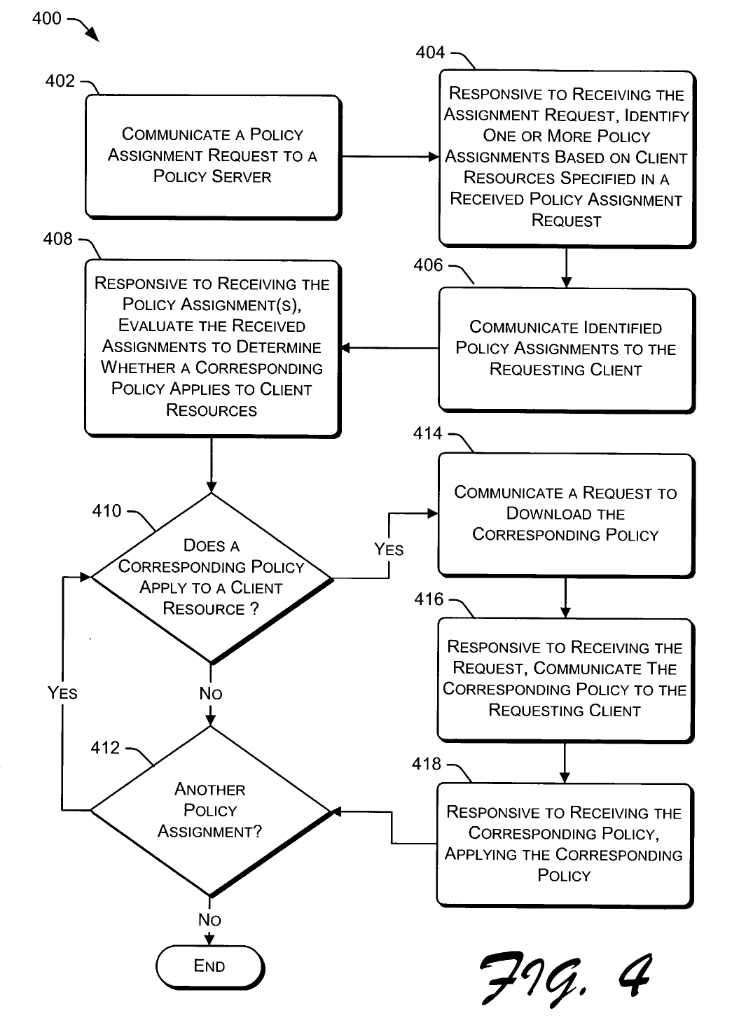

The policy manager module 118, responsive to receiving a request 122 (i.e., a request for a policy assignment 124 or a particular policy 126) from a client device 106, communicates one or more policy assignment objects 124 or policy objects 126 to the requesting client device 106. Further operational aspects of the policy manager module 118 are described in greater detail below in reference to the exemplary procedure to efficiently distribute policy of FIG. 4.

### An Exemplary Policy Assignment Object

A policy assignment object 124 is an object which ties a particular policy object 126 to a particular scope of management (SOM), and hence, a particular resource type (e.g., device/machine 106, application 138, or user of the device 106) to which the corresponding policy applies. A policy object 126 may support multiple resource types. The policy assignment 124 includes a number of queryable properties used by a client device 106 (and more particularly by a policy agent module 142 of the client device 106, which will be described in greater detail below) to identify the particular characteristics of a particular policy object 126. Such queryable properties of a policy assignment object 124 include, for example, a resource type indication and a policy category indication

The resource type indication identifies the particular resource (e.g., machine, user, and/or application) to which actions of a specified policy object 126 will apply. The resource type indication property will be specified by the policy agent 142 to selectively retrieve machine, user, and/or application policy 126 from the policy server 102, which will identify those policy assignment objects 124 that correspond to the specified resource type(s).

For instance, TABLE 1 shows an exemplary use of machine and user assignment requests 122 from a policy agent module 142 to a policy server 102, wherein the requests 122 are based on resource type and client device 106 policy state 150. The policy state contains the name of the policy authority from which a policy originated, a Policy ID that is unique to that authority, a version, the policy's current state with respect to the client, and a set of rules which contain the settings to be applied when the policy is active. The current policy state of a client may be indicated to be: (a) active (i.e., applied); (b) inactive; (c) ready to be applied; (d) applied; (e) not yet downloading the policy from the Policy Server; (f) actively downloading the policy and not yet finished; and (g) a general error state.

The identification (ID) information of TABLE 1 identifies a resource object to the MP. For example, a machine object may include a unique identifier (typically a Global Unique Identifier—GUID) in addition to the machine name. In another example, a user's ID information may consist of a user name and a Security Identifier (SID) for the user.

TABLE 1
EXEMPLARY MACHINE AND USER ASSIGNMENT OBJECT
REQUESTS

| Policy Assignment | Resource | ID | |
|---|---|---|---|
| Request | Type | Information | When |
| Machine Policy (M) | M | M | Boot, Schedule |
| User Policy (UM) | U, U ∩M | U, M | Logon, Schedule |

As illustrated in TABLE 1, requesting user policy is equivalent to requesting (user policy) union ((user ∩ machine) policy). In other words, user policy is the union of policies targeted at a user and policies targeted and at a user on a specific machine. User ∩ policy machine policy is a request for policy that is targeted at a particular user on a particular machine.

As indicated by the “when” column of TABLE 1, a policy assignment request may occur at different intervals depending upon the resource type of the policy. Machine policy is most efficiently requested at machine boot time and thereafter on a schedule. User policy is most efficiently requested when a user logs on and thereafter on a schedule. Querying for policy assignments 124 on the basis of application type may be useful in certain environments such as clustered servers, wherein an application moves between a machine in the cluster based on machine loading, or availability (i.e., an application is shutdown on one machine and then restarted on another, but logically the running image is ‘moved’). Querying for policy assignments 124 in an exchange mail server environment is useful when the server needs to get its policies for users, but not specific user's policy. An example of this would be the user's level of service related to the allowed size of their mailbox. This policy is relevant only to the mail application running on the server not to the user's client machine and therefore is not strictly user policy.

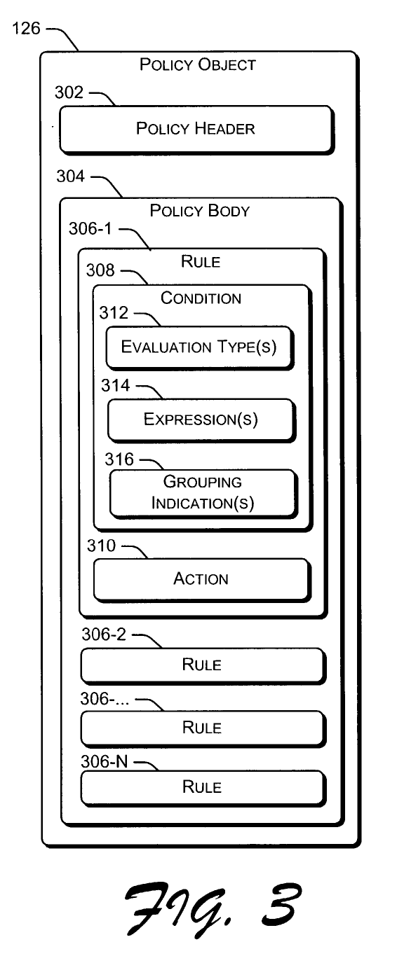

Additionally, the policy assignment object 124 includes information indicating how a particular policy object 126 should be applied and enforced on an identified resource, and further includes information indicating how the policy body should be retrieved by the policy agent module 142 from the policy object 126. The Policy body is described in greater detail below in reference to FIG. 3, and Tables 4 and 7.

FIG. 2 shows an exemplary block diagram of a policy assignment object 124. Multiple policy assignment objects 124 can be associated with a single policy object 126 in a particular policy server 102. This allows a same policy 126 to be targeted at different scopes of management within differing characteristics without the policy body having to be changed and copied.

The particular scopes of management associated with a specific policy assignment object 124 are provided by the assignment properties 202 and conditions of policy applicability 204. The assignment properties 202 indicate, for example, a policy authority to which the assignment belongs, the version of the policy, unique identification of the assignment object, and the location of the associate policy. Assignment properties may further contain a condition to be evaluated on the client machine that determines whether the assignment should be active for that client. For instance, such a condition may indicate that a particular assignment should only be active on machines running a particular operating system. The conditions 204 are evaluated by a particular client device 102, and more particularly, evaluated by a specific policy agent module 142, to determine whether the corresponding policy object 126 should be subsequently downloaded from the policy server 102 and applied to an indicated resource.

A policy assignment object 124 can be represented in any one of a number of different data formats such as Extensible Markup Language (XML) data format, which provides customized tags to define, validate, and transmit policy assignment object 124 data to a requesting client device 106. Such customized tags are also used by the client device 102 to parse a received policy assignment object 124. TABLE 2 shows aspects of an exemplary policy assignment 124.

TABLE 2
Aspects of an Exemplary Policy Assignment

<?xml version=‘1.0’ encoding=‘UTF-8’?>
<Assignment xmlns=‘x-schema:PolicyAssignment.xml’>
<PolicyAssignment>

<AssignmentID value=‘XXX123’>
<PolicyID value=‘ZZZ123’>
<PolicyVersion value=‘1:1’>
<PolicyCategory value=‘Core/Security/Network’>
<SchemaVersion value=‘1.02.001’>
<Description value=‘ITG standard security settings’>
<MandatoryDownload value=‘false’>
<PolicySize value=‘6560’>
<Condition type=‘WQL‘ positive=‘true’>
<Expression value=‘select * from win32_NetworkCard where type

= “Ethernet”>

</Condition>

</PolicyAssignment>

The Exemplary policy assignment of TABLE 2 is directed to policy objects 126 that apply organizational unit targeted security to specifically targeted enterprise resources, which in this example, are win32 Ethernet Network Cards. The elements or tags of the policy assignment are identified between open brackets “<” and closed brackets “>”, which include the following aspects:

“Assignment ID”—the ID of this assignment (unique for a particular SOM to policy assignment);

“AssignmentSource”—the name of the policy authority that generated the assignment.

“PolicyID”—identification of the particular policy object 126 that corresponds to this assignment object;

“PolicyVersion”—the version identifying the particular policy 126 associated with the PolicyID;

“PolicySource”—the name of the policy authority that generated the policy.

“Policy Category”—the area of policy such as a software update, security, a hierarchical namespace, and so on;

“SchemaVersion”—the schema version 128 of the policy;

“Description”—a textual description for this assignment;

“Priority”—a priority value indication that can be used for conflict resolution (e.g., a highest priority is indicated as having a priority zero (0), a lowest priority is indicated as having a priority of twenty (20)—these values are arbitrary and can be changed to reflect various implementation requirements);

“MandatoryDownload”—a Boolean true or false value ‘true’, ‘false’;

“PolicySize”—an indication of the size in bytes of the identified policy object(s) 126 (this indication may or may not include linked policies);

“Conditions”—expressions to be evaluated by the policy agent 142 to determine the applicability of the policy to the resources that correspond to the client device 106.

At least a subset of these various policy assignment 124 aspects are based on the policy assignment schema 128 of FIG. 1, which is utilized by the policy server 102 to enforce and identify the structure/characteristics of the policy assignment object(s) 124. If these particular objects 124 are stored on the database 132, the policy assignment schema 128 is used by the database management system (DBMS) 132 (e.g., an SQL DBMS) to enforce and identify the structure of the assignment objects 124.

### An Exemplary Policy Object 126

FIG. 3 is a block diagram that shows aspects of an exemplary policy object 126. The policy object includes, for example, the policy header 302, and one or more policy bodies 304. The policy header 302 includes identification and context information for the policy contained in the policy body 304. Some of these header fields may be shared with a particular policy assignment object 124. The policy header 302 does not include policy conditions, as these conditions are provided by at least one corresponding policy assignment object 124. Each policy header 302 includes at least a subset of the following elements or data fields:

“PolicyID”—a substantially unique ID that identifies this particular policy 126. Multiple versions of a particular policy 126 may have the same PolicyID so that machines or users still assigned to a previous policy may still get access to the prior version of the policy object, and indeed when they are assigned a newer version can efficiently update the policy as opposed to deleting the old one and creating a new one which would occur if the PolicyID changed.

“Policy Version”—the particular version of the policy, or policy body 304 that is specific to the PolicyID.

“PolicySource”—the policy authority that generated the policy.

“PolicyCategory”—The area of policy such as a software update, security, and so on, which may the identified as a hierarchical namespace.

“Source”—this data field provides an indication of an entity (e.g. company, organization, and so on) that authored the policy body 304.

“Description”—this data field provides the brief summary of the intention and/or applicability of the policy provided by the policy body 304.

“Schema Version”—this is a numeric indication that provides the version number of the policy as validated and the enforced by the policy management schema 128.

“BodyType”—this data field provides an indication of whether the policy body 304 represents more than a single policy. For instance, a single policy may be indicated as ‘single’, wherein a number of policies in the body 304 may be indicated as a ‘bundle’.

“LinkedItems”—this data field provides a Boolean indication of whether there is any linked content in the policy body 304. The linked content includes, for example, another self contain policy object. In one implementation, a policy body is linked to any number of other self contained policies to avoid duplication of the content of the policy body.

The aspects of the policy header 302 can be provided in any one of a number of various data formats such as in a XML data format. For instance, TABLE 3 shows aspects of an exemplary policy header 302.

TABLE 3
An Exemplary Policy Header

<?xml version=‘1.0’encoding=‘UTF-8’?>
<Policy xmlns=‘x-schema:Policy.xml’>
<PolicyHeader>

<PolicyID=‘SMS0001’>
<VersionID=‘0000001’>
<PolicyCategory value=‘SMS/Agents/HWInv’>
<Source value=‘Microsoft ITG’>
<Description value=‘SMS Settings for Hardware Inventory Agent’>
<Version value=‘1.01.00’>
<BodyType value=‘Single’>
<LinkedItems value=‘false’>

</PolicyHeader>

A policy bundle body 304 is a container for one or more policies and may contain sibling policy bundles or single policies. The various aspects of a single policy body 304 or a policy bundle body 304 can be accessed via one or more in-line links such as a Universal Resource Locator (URL) that identifies a file or document corresponding to a policy. TABLE 4 shows an exemplary policy body 304.

TABLE 4
Exemplary Policy Headers and a Policy Bodies

<?xml version=‘1.0’encoding=‘UTF-8’?>
<Policy xmlns=‘x-schema:Policy.xml’>
<PolicyHeader>

<BodyType value=‘Bundle’>
<LinkedItems value=‘true’>
...

</PolicyHeader>
<PolicyBody Type=‘Bundle’>
<PolicyItem Label=‘RAS policy’ Content=‘linked’>

| | |
|---|---|
| <Reference | value=“mgmt\policy\network\ras\po1003.xml” |

version=“1.02.00”>

</PolicyItem>
<PolicyItem Label=‘DHCP policy’ Content=‘inline’>

<?xml version=‘1.0’ encoding=‘UTF-8’?>
<Policy xmlns=‘x-schema:Policy.xml’>
<PolicyHeader>

<BodyType value=‘Single’>
<LinkedItems value=‘false’>
...

</PolicyHeader>
<Policy Label=‘DHCP policy’ Content=‘inline’>
...
</Policy>

</PolicyItem>
</PolicyBody>

The policy headers 302 of TABLE 4 are identified with corresponding <PolicyHeader> and </PolicyHeader> tag elements. The policy bodies 304 of TABLE 4, along with corresponding policy headers 302, are identified between the respective <PolicyBody> and </PolicyBody> tag elements. The specific policy bodies 304 include that information specified between corresponding <PolicyItem> and </PolicyItem> tag elements. In this example, the policy body bundle 304 includes both a linked policy and an in-line policy.

Each policy body 304 includes one or more policy rules 306. Each policy rule 306 includes a substantially unique identifier to distinguish it from other rules 306. Additionally, a policy rule 306 includes zero (0) or more policy conditions 308 and one or more policy actions 310. Each policy condition 308 includes one or more evaluation type indications 312, one or more expressions 314, and one or more grouping indications 316. A policy condition 308 can be presented in any of a number of different data formats such as the XML data format. For instance, TABLE 5 shows an exemplary policy condition 308 in the XML data format.

TABLE 5
An Exemplary Policy Condition

<Condition>

<type value=‘UNTIL_TRUE’>
<grouping value=‘AND’>

<Expression type=‘WQL’ positive=‘true’ value=‘select * from
win32_NetworkCard where type = “Ethernet”>
<Expression type=‘WQL’ positive=‘true’ value=‘select * from
win32_OperatingSystem where Locale = “409”>

</grouping>

</Condition>

A particular policy condition 308 can appear in a number of different places such as in the policy rule 306 and/or in a corresponding policy assignment object 124.

An evaluation type indication 312 defines how the expression(s) 314 in the condition 308 should be evaluated. Evaluation type indications 312 include, for example, the following evaluation indications:

UNTIL_TRUE—indicates that they condition 308 is to be evaluated until the condition 308 becomes true. If the condition 308 becomes true that no further client device 106 evaluation of the condition 308 needs to occur.

CONTINUOUS—indicates that the condition 308 is to be continuously evaluated, regardless of whether the condition has previously been through and regardless of whether the rule action 310 that corresponds to the condition 308 has already been applied.

ONCE—indicates that the condition 308 should be evaluated only one time.

An expression 314 may be expressed as XML, managed or unmanaged script code, and so on. Each expression 314 yields a positive or negative result. Each grouping attribute 316 declares how multiple expressions within the policy condition 308 are to be combined and/or evaluated. For instance, the grouping value 316 may be expressed as Boolean values that indicate any number of expressions 314 are to be combined utilizing various combinations of logical “AND”, “OR”, and/or “NOT” operations.

The policy action 310 provides one or more operations for a policy agent 142 to perform in the event that one of the zero (0) or more conditions 308 or criteria corresponding to the policy action 310 are satisfied. (Zero conditions can indicate criteria that the action 310 is to be applied). The content of the action 310 settings, which are opaque to the policy server 102, can be presented in any manner that is appropriate to the policy's targeted resource(s). Thus, the contents of the policy action 310 can be expressed in any data format such as XML, Multipurpose Internet Mail Extension (MIME), and so on, as dictated by a particular implementation. For instance, TABLE 6 shows aspects of an exemplary policy action 310 that uses WINDOWS Management Instrumentation (WMI) Managed Object Format (MOF).

TABLE 6
An Exemplary Policy Action

<?MIME type ? encoding=‘UTF-8’>

#pragma namespace(“\\\\.\\Root\\UMC\\Settings\\Request”)

```
// instance of an action request for SW install agent
    instance of UMC_ActionRequestConfig
    {
```

ActionID = 123;
AgentID = “ID:XYZ”;
ScheduleID = “ID:123”;

};

As illustrated below, TABLE 7 provides an exemplary policy object 124 that includes policy headers 302 aspects as well as various policy body 304 aspects (e.g. rules 306, conditions 308, evaluation types 312, expressions 314, grouping indications 316, and actions 310).

TABLE 7
An Exemplary Policy Object

<?xml version=‘ 1.0’encoding=‘UTF-8’?>
<Policy xmlns=‘x-schema:Policy.xml’>
<PolicyHeader>

| | |
|---|---|
| <BodyType | value=‘Single’> |

<LinkedItems value=‘false’>

...
</PolicyHeader>
<PolicyBody Type=‘Single’>
<Rule RuleID=‘123456’>
<Rule Label=‘SMS software install’>

<Condition>

<Expression type=‘WQL’ positive=‘true’ value=‘ select * from
win32_operatingsystem where Caption = “Microsoft Windows 2000
Professional”’>

```
</Condition>
<Action Type=WMISettings Description=‘Tweak Reg values’>
  <?MIME type ? encoding=‘UTF-8’?>
    #pragma namespace(“\\\\.\\Root\\UMC\\Settings\\Request”)
// instance of an action request for SW install agent
```

instance of UMC_ActionRequestConfig
{

ActionID = 123;
AgentID = “ID:XYZ”;
ScheduleID = “ID:123”;

};
instance of UMC_ScheduleRequestConfig
{

ScheduleID = “ID:123”;
StartTime = “20010124105418.815684-480”;
RunFlags = 8;

};

// specific settings for the SW install agent for this action
instance of UMC_SWRequestConfig

{

ActionID = 123;
CmdLine = “setup /S”;
// Reference to content to be retrieved by agent
ContentKey = “SMS0002:PROG1:SMS0004”;
Options = 24;

};

</Action>

</Rule>
</PolicyBody>

### An Exemplary Client for Selectively Evaluating and Downloading Policy

The client device 106 includes a processor 134 coupled across a bus to a system memory 136. The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

The system memory 136 includes a variety of computer-readable media. Such media may be any available media that is accessible by the processor 134, and it includes both volatile and non-volatile media, removable and non-removable media. For example, the system memory 136 includes computer readable media in the form of volatile memory, such as random access memory (RAM), and/or non-volatile memory, such as read only memory (ROM). A basic input/output system (BIOS), containing the basic routines that help to transfer information between elements within computer 102, such as during start-up, is stored in ROM. RAM typically contains at least portions of program modules 138 and/or data 140 that are immediately accessible to and/or presently be operated on by the processor 134.

The processor 134 is configured to fetch and execute computer program instructions from applications or program modules 138 portion of memory 136. The processor 134 is also configured to fetch data from the data 140 portion of memory 136 while executing the program modules 138.

Program modules 138 may be described in the general context of computer-executable instructions being executed by a computer. Generally, program modules 138 include routines, programs, objects, components, data structures, etc., that perform particular tasks or implement particular abstract data types. Exemplary systems and procedures to download assignments 124 and policy 126 from a policy server 102 may be performed by program modules 138 that are executing on remote processing devices that are linked through a communications network. Accordingly, program modules 138 may be located in both local and remote computer storage media including memory storage devices.

The program modules 138 of the client device 106 include, for example, the policy agent module 142, and other modules 120 such as an operating system. Data 140 includes policy one or more assignment objects 124, one or more policy objects 126, policy state information 150, and other data 152. Further aspects of the operation of the client device 106 with respect to the policy server 102 are described in greater detail below with respect to FIG. 4, which shows aspects of an exemplary procedure to efficiently distribute and implement policy.

Computer-Readable Media

Exemplary subject matter to efficiently distribute and implement policy may be stored on or transmitted across some form of computer-readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

### An Exemplary Procedure to Efficiently Distribute and Implement Policy

FIG. 4 shows an exemplary procedure 400 to efficiently distribute policy. The operations of this procedure 400 are respectively performed by a policy server 102 and a client device 106. Accordingly, policy server operations are represented by blocks 404, 406, and 414, and client device operations are represented by blocks 402, 408, 410, 412, 414, and 416.

At block 402, the client device 106, and more particularly the policy agent module 142 generates and communicates a policy assignment request 122 to the policy server 102. The policy assignment request 122 indicates one or more resources of the client device's 106 execution environment (e.g., machine, application, and/or user resource types) so that specific policy assignment objects 124 can be identified and returned to the client device 106 by the policy server 102. In this manner, the client device 106 is able to selectively retrieve machine, application, and/or user policy assignment objects 124 from the policy server 102.

At block 402, the policy server 102 responsive to receiving the policy assignment request 122 from the client device 106, identifies one or more policy assignment objects 124 based on the client 106 specified resources, which are identified in the received policy assignment request 122. At block 406, the policy server communicates the identified policy assignments 124 to the requesting client device 106.

At block 408, the client device 106, responsive to receiving the policy assignment 124 from the policy server 102, evaluates aspects of the policy assignment 124 (e.g., resource type indications, policy category indications, conditions, and so on) to determine whether the corresponding policy 126 or policy bundle 126 that is referenced in the policy assignment object 124 particularly applies to the client 106 specified resources (e.g., see block 402). At block 410, the client device 106 having determined that the policy 126 referenced in the received policy assignment object 124 should not be applied to any resources associated with the client device 106, does not download the policy 126. At block 412, the client device 106 determines whether there are any other policy assignments received from the policy server that should be evaluated. If additional policy assignments are to be evaluated for applicability to the client device, the procedure continues at block 410 as discussed above, otherwise this portion of the procedure 400 ends.

At block 414 (the client device 106 having determined at block 410 that the policy 126 that is referenced by the received policy assignment object 124 does apply to at least one resource (e.g., machine, application, and/or user) that is associated with the device 106), communicates a policy object request 122 to the policy server 102, and more particularly to the policy manager module 118. The policy object request references the particular policy object 126 that was indicated in the policy assignment object 124 evaluated by the client device 106.

At block 416, responsive to receiving the policy object request 122 from the client device 106, the policy server 102 and more specifically the policy manager module 118 communicates the client 106 requested policy object 126 to the client 106. At block 418, responsive to receiving the requested policy object(s) 126, the client device 106 applies the corresponding policy actions 310 to appropriate resources associated with the client device 106. The procedure continues at block 412 as discussed above.

Conclusion

The described arrangements and procedures provide for efficiently distributing and implementing policy. Although the arrangements and systems to efficiently distribute and implement policy have been described in language specific to structural features and methodological operations, it is to be understood that the arrangements and procedures as defined the appended claims are not necessarily limited to the specific features or operations described. Rather, the specific features and operations are disclosed as preferred forms of implementing the claimed subject matter.

1. A method to efficiently distribute policy, the method comprising:
generating a policy comprising an action to be applied to a resource; and
creating a policy assignment in association with but separate from the policy, the policy assignment comprising a reference to the policy and criteria for a client to determine appropriateness of subsequent access to the policy to apply the action to the resource.

2. A method as recited in claim 1, wherein the criteria is a condition.

3. A method as recited in claim 1, wherein the criteria is the lack of a condition.

4. A method as recited in claim 1, wherein the policy is a bundle of policies.

5. A method as recited in claim 1, wherein the policy is an in-line policy or a linked policy.

6. A method as recited in claim 1, wherein the action will be implemented by the client only if the criteria in the assignment are satisfied with respect to the resource at the client.

7. A method as recited in claim 1, further comprising.
receiving a request from the client;
selecting the policy assignment based on the request; and
communicating the assignment to the client.

8. A method as recited in claim 7, wherein the resource corresponds to any combination of a machine, application, and/or user resource, and wherein the request comprises a resource type; and wherein the method, before communicating the assignment to the client, further comprises evaluating the resource type to identify the assignment from of a plurality of other assignments such that the assignment corresponds to the resource type.

9. A method as recited in claim 7, wherein the request is a first request, and wherein the method further comprises:
receiving a second request from the client, the second request comprising the reference; and
responsive to receiving the second request, communicating the policy to the client.

10. A method as recited in claim 9, wherein communicating the assignment and communicating the policy are both performed by a policy server.

11. A method as recited in claim 9, wherein communicating the assignment is performed by a policy server, wherein the assignment further comprises a location for the client to download the policy, and wherein communicating the policy is performed by a server that is independent of the policy server, the server corresponding to the location.

12. A computer-readable medium comprising computer-executable instructions to efficiently distribute policy, the computer-executable instructions comprising instructions for:
generating a policy comprising an action to be applied to a resource; and
creating a policy assignment in association with but separate from the policy, the policy assignment comprising a reference to the policy and criteria for a client to determine appropriateness of subsequent access to the policy to apply the action to the resource.

13. A computer-readable medium as recited in claim 12, wherein the criteria is a condition.

14. A computer-readable medium as recited in claim 12, wherein the criteria is the lack of a condition.

15. A computer-readable medium as recited in claim 12, wherein the policy is a bundle of policies.

16. A computer-readable medium as recited in claim 12, wherein the policy is an in-line policy or a linked policy.

17. A computer-readable medium as recited in claim 12, wherein the action will be implemented by the client only if the criteria in the assignment are satisfied with respect to the resource at the client.

18. A computer-readable medium as recited in claim 12, further comprising computer-executable instructions for.
receiving a request from the client;
selecting the policy assignment based on the request; and
communicating the assignment to the client.

19. A computer-readable medium as recited in claim 18, wherein the resource corresponds to any combination of a machine, application, and/or user resource, and wherein the request comprises a resource type; and wherein the computer-executable instructions, before the instructions for communicating the assignment to the client, further comprises instruction for evaluating the resource type to identify the assignment from of a plurality of other assignments such that the assignment corresponds to the resource type.

20. A computer-readable medium as recited in claim 18, wherein the request is a first request, and wherein the computer-executable instructions further comprise instructions for:
receiving a second request from the client, the second request comprising the reference; and
responsive to receiving the second request, communicating the policy to the client.

21. A computer-readable medium as recited in claim 20, wherein communicating the assignment and communicating the policy are both performed by a policy server.

22. A computer-readable medium as recited in claim 20, wherein communicating the assignment is performed by a policy server, wherein the assignment further comprises a location for the client to download the policy, and wherein communicating the policy is performed by a server that is independent of the policy server, the server corresponding to the location.

23. A computing device comprising a processor coupled to a memory, the memory comprising the computer-executable instructions as recited in claim 12, the processor being configured to fetch and execute the computer-executable instructions to efficiently deliver policy.

24. A computing device comprising processing means to execute the computer-executable instructions as recited in claim 12 to efficiently deliver policy.

25. A method for efficiently determining policy, the method comprising:
communicating, by a client, a policy assignment request to a policy server, the policy assignment request identifying one or more resource types associated with the client;
receiving one or more policy assignments based on the one or more resource types from the policy server;
evaluating criteria of the one or more policy assignments to determine whether one or more policies that correspond to respective ones of the one or more policy assignments apply to the one or more resources; and
wherein the one or more policies have not been downloaded to the client.

26. A method as recited in claim 25, wherein the criteria is a condition that comprises an evaluation type and an expression.

27. A method as recited in claim 25, wherein the criteria is a condition that comprises a plurality of expressions and a grouping indication to identify an order to evaluate at least a subset of the expressions.

28. A method as recited in claim 25, wherein the one or more resource types comprise any combination of machine, user, and/or application resource types.

29. A method as recited in claim 25, wherein first and second policy assignments of the one or more policy assignments respectively comprise different first and second priority values, and wherein the method further comprises determining, based on the first and second priorities, that a first policy corresponding to the first policy assignment has a higher priority than a second policy corresponding to the second policy assignment.

30. A method as recited in claim 25, further comprising:
responsive to determining that a particular one policy of the one or more policies applies to at least one of the one or more resources, communicating a policy object request to the policy server or to an entity associated with the policy server, the policy object request identifying the particular one policy; and
responsive to receiving the particular one policy, applying corresponding policy actions to the at least one of the one or more resources.

31. A computer-executable medium comprising computer-readable instructions for efficiently determining policy, the computer-readable instructions comprising instructions for:
communicating, by a client, a policy assignment request to a policy server, the policy assignment request identifying one or more resource types associated with the client;
receiving one or more policy assignments based on the one or more resource types from the policy server;
evaluating criteria of the one or more policy assignments to determine whether one or more policies that correspond to respective ones of the one or more policy assignments apply to the one or more resources; and
wherein the one or more policies have not been downloaded to the client.

32. A computer-readable medium as recited in claim 31, wherein the criteria is a condition that comprises an evaluation type and an expression.

33. A computer-readable medium as recited in claim 31, wherein the criteria is a condition that comprises a plurality of expressions and a grouping indication to identify an order to evaluate at least a subset of the expressions.

34. A computer-readable medium as recited in claim 31, wherein the one or more resource types comprise any combination of machine, user, and/or application resource types.

35. A computer-readable medium as recited in claim 31, further comprising computer-executable instructions for:
responsive to determining that a particular one policy of the one or more policies applies to at least one of the one or more resources, communicating a policy object request to the policy server or to an entity associated with the policy server, the policy object request identifying the particular one policy; and
responsive to receiving the particular one policy, applying corresponding policy actions to the at least one of the one or more resources.

36. A computing device comprising a processor coupled to a memory, the memory comprising the computer executable instructions as recited in claim 31, the processor being configured to fetch and execute the computer-executable instructions to efficiently determine policy.

37. A computing device comprising processing means to execute the computer-executable instructions as recited in claim 31 to efficiently determine policy.

38. A computer-readable medium comprising multiple data structures to efficiently distribute policy, the computer-readable medium comprising:
a policy assignment data structure that contains information to reference a policy, and criteria for the client device to determine whether to subsequently download and apply the policy; and
a policy data structure that contains the policy and corresponding actions; and
wherein the computer-readable medium is managed by a database management system that manages the policy assignment data structure in association with but separately from the policy data structure.

39. A computer-readable medium as recited in claim 38, wherein the computer-readable medium is a database.

40. A computer-readable medium as recited in claim 38, wherein the criteria is a condition that contains at least one expression.

41. A computer-readable medium as recited in claim 38, wherein the criteria is at least one expression and an evaluation type selected from evaluate the at least one expression until true or evaluate the at least one expression continuously.

42. A computer-readable medium as recited in claim 38, wherein the criteria is at least one expression and an indication of an order of evaluation to apply to the at least one expression.

43. A computer-readable medium as recited in claim 38, wherein the policy assignment data structure further comprises an indication of at least one resource to which the policy is to be applied.

44. A computer-readable medium as recited in claim 38, wherein the policy assignment data structure further comprises an indication of at least one resource to which the policy is to be applied, and wherein the at least one resource is any combination of a machine, application, and/or user resource.

45. A computer-readable medium as recited in claim 38, wherein the policy assignment data structure further comprises a location indicating where the client device can access the policy.

46. A computer-readable medium as recited in claim 38, wherein the policy assignment data structure further comprises a policy category to classify the policy in one or more categories such as a namespace model and/or a software application area

47. A computer-readable medium as recited in claim 38, wherein the database further comprises a policy management schema to enforce structure and/or characteristics of the policy assignment data structure and/or the policy data structure.
